(19) United States
(12) Patent Application Publication
(10) Pub. No.: US 2025/0100140 A1
(43) Pub. Date: Mar. 27, 2025

(54) AUTONOMOUS END EFFECTOR SELECTION AND MOUNTING

(71) Applicant: Dexterity, Inc., Redwood City, CA (US)

(72) Inventors: Andrew Lovett, San Mateo, CA (US); Jordan Cedarleaf-Pavy, Mountain View, CA (US); Prabhat Sinha, Santa Clara, CA (US); Samir Menon, Atherton, CA (US); Zhouwen Sun, San Mateo, CA (US)

(21) Appl. No.: 18/896,341

(22) Filed: Sep. 25, 2024

Related U.S. Application Data
(60) Provisional application No. 63/540,303, filed on Sep. 25, 2023.

(51) Int. Cl. B25J 9/16; B25J 15/04; B25J 15/06; B25J 19/02

(52) U.S. Cl. CPC B25J 9/1661; B25J 9/162; B25J 9/1653; B25J 9/1697; B25J 15/0408; B25J 15/0491; B25J 15/0616; B25J 19/023

(57) ABSTRACT

A robotic system with autonomous gripper selection is disclosed. Sensor data is received from a sensor in a workspace. The sensor data is used to determine an end effector to be used to perform a task with respect to an object in the workspace. The determined end effector is autonomously mounted on a free moving end of a robotic arm comprising the robotic system, and the robotic arm and end effector are used to perform the task with respect to the object.

### CROSS REFERENCE TO OTHER APPLICATIONS

This application claims priority to U.S. Provisional Patent Application No. 63/540,303 entitled AUTONOMOUS GRIPPER SELECTION filed Sep. 25, 2023 which is incorporated herein by reference for all purposes.

### BACKGROUND OF THE INVENTION

Autonomous and human-controlled robots have been provided and used to perform a wide variety of tasks, such as picking and placing items, loading and unloading trucks or pallets, performing sortation, line or shelf kitting systems, etc.

To date, typically, different robots have been required to complete similar but distinct tasks, since each robot had a specific tool which could only be changed by human operators. For example, a first robot might be required to handle smaller items, and a second robot, e.g., one with higher lifting capacity and/or a larger and/or more powerful end effector, to handle larger items.

Some robot systems had access to multiple tools, but only in a strictly scripted operation. Some robots have been configured to have the end effector or “end of arm tool” changed out, but typically this required human intervention. Such approaches are not sufficient to perform work requiring frequent switching between handling different types of packages that may require different gripper types, such as picking items from an arbitrary set of items of different shapes, sizes, weights, etc.

Some have attempted to provide a ‘universal gripper’—i.e., a gripper that can handle a number of different types of objects; but typically, such ‘universal’ grippers have in practice been able to handle only a selected number of different types of object.

### BRIEF DESCRIPTION OF THE DRAWINGS

Various embodiments of the invention are disclosed in the following detailed description and the accompanying drawings.

FIG. 1 is a diagram illustrating an embodiment of a robotic system with autonomous gripper selection.

FIG. 2 is a flow diagram illustrating an embodiment of a process to perform a robotic task with autonomous gripper selection.

FIG. 3 is a flow diagram illustrating an embodiment of a process to select a gripper autonomously to perform a task.

FIG. 4 is a flow diagram illustrating an embodiment of a process to perform a task using a selected gripper.

FIG. 5 is a flow diagram illustrating an embodiment of a process to perform a set of tasks potentially requiring use of two or more different grippers.

FIG. 6 is a flow diagram illustrating an embodiment of a process to determine and assemble a set of grippers to be used to perform tasks associated with a robotic application.

FIG. 7A is a diagram illustrating an example of a gripper mounting mechanism in an embodiment of a robotic system with autonomous gripper selection.

FIG. 7B is a diagram illustrating an example of a gripper mounting mechanism in an embodiment of a robotic system with autonomous gripper selection.

FIG. 7C is a diagram illustrating an example of a gripper mounting mechanism in an embodiment of a robotic system with autonomous gripper selection.

FIG. 8 is a diagram illustrating an example of a gripper mounting mechanism in an embodiment of a robotic system with autonomous gripper selection.

FIG. 9 is a diagram illustrating an example of a gripper mounting mechanism in an embodiment of a robotic system with autonomous gripper selection.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A robotic system that autonomously determines and selects for each task one of a plurality of end effectors or other tools, and autonomously controls a single robot, such as a robotic arm, to switch between using the respective selected tools, each to perform a corresponding set of one or more tasks, is disclosed.

In various embodiments, a robotic system as disclosed here is used in the context of AI-powered robot systems with multiple distinct capabilities. The AI system selects and switches between multiple different gripper tools based on the specific needs of the next task. In some embodiments, robots swap grippers and/or other tools by selecting the appropriate gripper or tool from a ‘gripper storage area’, with the tool being selected based on the need, e.g., one or more attributes of a next task, such as the size, weight, fragility, etc. of an item to be grasped next.

The terms “gripper”, “tool”, “end effector”, and “end of arm tool” or “EOAT” are used interchangeably to refer to a structure configured to be mounted autonomously to the operable (i.e., distal) end of a robotic arm or other robotic instrumentality, used to engage an object to perform a task autonomously using the robotic arm or other robotic instrumentality, and (at least eventually) dismounted autonomously from the robotic arm or other robotic instrumentality, e.g., in preparation to mount a different such structure to perform one or more other tasks. A “gripper” or other “end effector” in this sense may be used to interact with an object in ways other than grasping the object, such as a small conveyor used transport objects over a small distance, a small shovel or spatula or like structure used to scoop an object from below, other tools such as a welder, cutter, drill, screwdriver, or jackhammer, etc.

The term “robotic arm” is used herein to describe a robotic arm or other robotic instrumentality capable of having a gripper or other tool mounted onto an operable (i.e., free moving) end thereof.

In prior systems, robots having a single end effector (e.g., gripper, tool) exhibited one or more of the following technical shortcomings:
1. Robots unable able to handle different types/classes of objects
   a. Cardboard Boxes with different dimensions
   b. Trays holding items
   c. Paper Envelope
   d. Plastic bags, etc.
   e. small objects (E.g., toothpaste, etc.)
2. Robots unable to handle different weights or dimensions
   a. Heavy weight object may need a different gripper type than a lightweight object
   b. large objects may need a different gripper type than a small object
3. Robots unable to handle objects with different types of content
   a. A box with fragile content may require a gripper that secures the object/package better than a standard object
4. Robots unable to achieve optimal performance across different object types
   a. some grippers may be able to hold and move a variety of objects, but the robot will be forced to move slowly due to the gripper's poor grasp on the object
5. Robots unable to adapt to different environmental conditions
   a. environmental temperature and humidity
   b. nearness of human operators, automation systems, obstacles
6. Robots unable to quickly recover from hardware failures

In various embodiments, a robotic system as disclosed herein addresses the above shortcomings via one or more of the following:

“Gripper” (or “tool”) wall—In various embodiments, the location and related mechanisms which store the various grippers/tools may be a “gripper wall” from which the robot selects and obtains a gripper/tool for use, uses it, then returns it to the wall. In some embodiments, a gripper/tool repository other than a “wall” may be used; however, as used herein the term “wall,” may refer to a wall or to other storage solutions such as a “tool belt” (multiple grippers around the base of the robot), bin, carousel, etc.

Decision Criteria-A decision framework to drive appropriate gripper selection for the specific need. For example, computer vision may be used to determine an object's attributes, and logic and/or machine learning models used to select an appropriate gripper/tool.

Gripper swap-Based on the need, robot goes to the gripper wall, detaches current gripper (e.g., quick-detach mechanism) with robot motion assist, and replaces it with a new gripper (e.g., quick-attach mechanism).

In various embodiments, the steps/techniques disclosed herein are autonomous and require limited to no manual intervention.

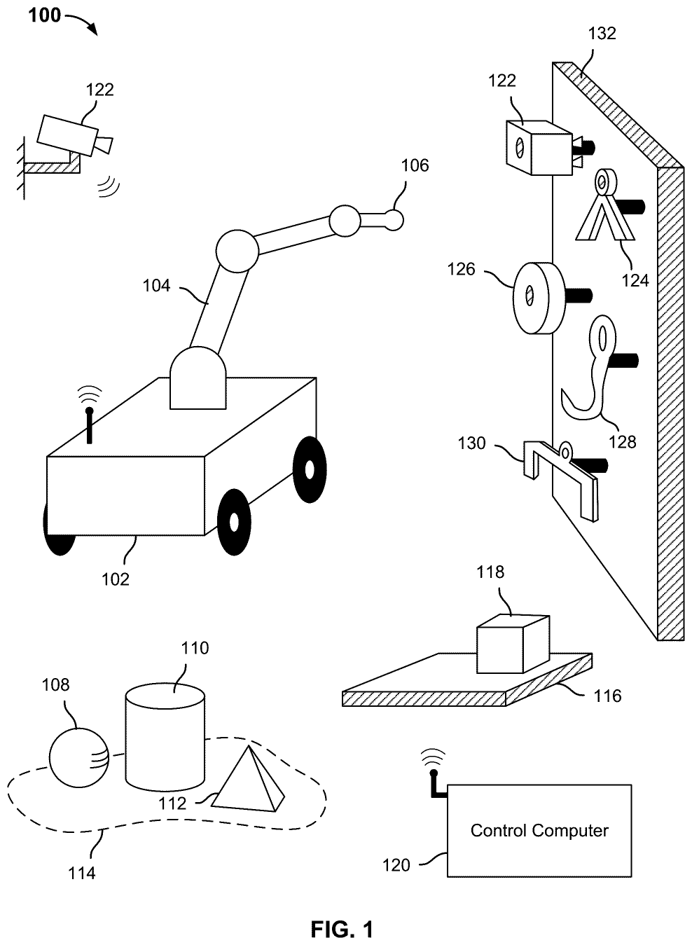

FIG. 1 is a diagram illustrating an embodiment of a robotic system with autonomous gripper selection. In the example shown, system and environment 100 includes a robotically controlled rover 102 having a robotic arm 104 mounted thereon, the robotic arm 104 having end effector mounted structure 106 at a distal end. In some alternative embodiments, robotic arm 104 is mounted in a fixed position or on a mobile chassis that is not robotically controlled.

As shown in FIG. 1, robot 102, 104 is positioned and assigned to pick items, such as items 108, 110, and 112, from a pick area 114 and place them at a destination, in this case pallet 116, on which item 118 is shown to have been placed.

Robot 102, 104 is operated under the control of control computer 120. Control computer 120 is shown to be separate from robot 102, 104 in the example shown in FIG. 1, but in some alternative embodiments the control computer 120 may be on and/or integrated with robot 102, 104.

The control computer 120 uses image data generated by camera 122 to generate a three-dimensional view of the workspace comprising system and environment 100. In various embodiments, one or more additional cameras and/or other sensors may be used to generate a three-dimensional view of the workspace. While in the example shown the control computer 120 is in wireless communication with the robot 102, 104 and the camera 112, in other embodiments wired or other connections may be used.

Camera 122 provides a view of grippers 122, 124, 126, 128, and 130 mounted on a gripper wall 132. While in the example shown in FIG. 1 the grippers 122, 124, 126, 128, and 130 are mounted on gripper wall 132, in various embodiments the grippers may be mounted, placed, or otherwise arrange for display and access on a structure or set of structures other than a gripper wall.

In various embodiments, the control computer 120 uses images from camera 122 to determine a plan to pick and place items, e.g., 108, 110, 112, 118, from the pick area 114 to the destination 116. For each item, the plan includes and takes into consideration a selection of a gripper, e.g., from among grippers 122, 124, 126, 128, and 130, to perform that task. Gripper selection may be based on a determination of an item's type and/or one or more attributes of the item. For example, the size, shape, estimated weight, or other attributes may be determined based on images from camera 122. In some cases, images from camera 122 may be used to determine item attributes, either by reading attribute data as displayed on the item, e.g., an explicitly listed weight or by mapping a name, number, or other identifier to an attribute.

In various embodiments, a robot may select and grasp a tool from one or more of:
a wall in or near the robot and/or work zone;
a “tool belt” with tools stored around the base of the robot;
a “tool bench” with tools stored on a horizontal surface near the bot;
“hanging tools” with tools stored on a horizontal or angled surface above the bot;
some other tool receptacle or repository accessible to the robot;

In various embodiments, a robotic system as disclosed herein may rely on one or more of computer vision, force sensing, and knowledge and/or memory of the workspace to locate and mount a gripper. For example, in some embodiments, grippers may be arranged in predetermined location on a gripper wall or other structure. The location, dimensions, orientation, etc. of the wall (or other structure) may be provided to the robot as configuration data. Alternatively, the robot may use computer vision to locate the wall and identify the grippers positioned on the wall and estimate the location and orientation of each. The configuration and/or vision data may be used to position a gripper mount on the distal end of the robot to a position near the gripper to be mounted. Force control may be used to make fine adjustments to align the gripper mount on the robot with the corresponding structure on the selected gripper and force control may be used to manipulate the robot as needed to cause the gripper to be mounted. Depending on the mounting interface and hardware, for example, the mounting structure at the end of the robot may be pushed into a receiving structure on the gripper and/or rotated as/if necessary to secure mount the gripper.

Grippers of any type may be used, including without limitation:
clamping/encapsulating (grab pallet, etc.)
suction grasping
“scoop” or “spatula” grasping from beneath.
magnetic tool.
“hook” tool for objects with handles/loops
computer vision calibration tool
self-discovery tool (use to locate known features in the world or on the robot itself)
can calibrate actual robot joints this way
Multi-part grippers
robot can combine suction and spatula, or two orthogonal suction surfaces, etc.
specific known situations trigger specific strategies
few individual grippers turn into many overall tool strategies (3 tools gives 6+ overall gripper options)
Other variations are possible:
Size/dimensions (small, big)
shape (square, rectangle, circle, etc)
angle (parallel to robot flange, perpendicular, angled)

In various embodiments, one or more techniques may be used by the robot to identify a gripper, either one that is mounted on the robot or one in the workspace. In various embodiments, one or more of the following may be used:
RFID or other electronic tag
Barcode, QR code, or other optical code scan
Mechanically sensed, e.g., by location of a structure or recess relative to a reference
Vision

In some embodiments, tool verification/incompatibility detection may be used to prevent unauthorized tools from being used, e.g., by a robot not rated for the tool and/or use of a tool not appropriate to a given task. In some embodiments, tool identification may be used to catch operator/installer errors, detect that a tool has been placed (by robot, human) in an incorrect place on wall, etc.

In some situations, the robot system might turn on with no memory of what tools are available to it. In various embodiments, one or more of the following techniques may be used:
use vision to identify tool types and locations in the environment
use vision to identify object types in the environment
pick correct gripper/tool tuned for the object type

In various embodiments, tool selection may be determined by one or more of the robotic application or task to be performed, the environment in which the robot is working, and/or other constraints. Considerations may include one or more of the following:
In the proximity of a human, use compliant/soft or lightweight grippers
When the pallet state is smooth, use a large gripper module for simple operation.
When the pallet state is bumpy, use smaller modules such that the motion planning collision computation is simplified
When putting into a truck use a narrow-offset gripper to handle the specific challenges of truck operations
Constrained space
When putting to one pallet vs. 2 vs. 3 vs. 4=>take into account placement constraints
When the environment is hot or cold, switch to gripper type that handles that effectively

The gripper typically is a high touch point on a robot system. Occasionally parts of the gripper will reach end of life and need to be replaced. In various embodiments, the robot/gripper has performance monitoring capabilities built in. The system will notice if performance is degrading. In various embodiments, the robot has access to spares of the grippers/tools it uses frequently. When the system notices performance degradation, it can automatically trigger a tool change when it is the right time. A repair site may be notified that new spare is needed in cell and that old gripper should be removed. The robotic system is made aware when spare is replaced, so that if it is not the robot does not try to use an old gripper.

A wide variety of grippers of different types may be used. In various embodiments, one or more of the following may be performed:
Each is studied and/or observed, by humans and/or via machine learning, to learn which gripper to use in which situation/context.
Each gripper is engineered to enable techniques disclosed herein
Include features to pick up the gripper/tool, e.g., from the gripper wall
E.g., robotic arm and gripper(s) each designed to facilitate easy, quick, secure swapping out of tools
Find specific instances of how every conceivable type of suction device or other gripper is utilized in a very specific robot-enabling manner
Machine learning, heuristics, etc. to know/learn which gripper/tool to use for a given task in a given context
Some tools may comprise and/or include a sensor, e.g., a camera, a force sensor or other device to measure weight, a ruler or similar structure to measure physical dimensions, etc.
Sensor/measuring tool used to determine attribute of object and/or area; sensed/measured value used to select tool to perform next task

In some situations, the robot system might turn on with no memory of what tools are available to it. In various embodiments, one or more of the following techniques may be used:
use vision to identify tool types and locations in the environment
use vision to identify object types in the environment
pick correct gripper/tool tuned for the object type

In some embodiments, robots may roam between stations each of which has a station specific tool or set of tools associated with it. One mobile robot may cover multiple stations. If each station is for a specific SKU or object type, the tool for that object type can be stored at the station. When a robot leaves one station, it leaves the tool there, then when it arrives at the new station it picks up the new tool at that station. The tool(s) may remain at the station, so another robot (or the same one) will have it available at the station.

While in the example shown in FIG. 1 the robot has one robotic arm, in other embodiments a robot may have two or more arms. In some embodiments, the robotic system may select a different type or size of end effector for each of the two (or more) arms. The arms may be used in cooperation, with the different end effectors being used cooperatively but in different ways to perform a task. For example, one end effector may have the shape of a ramp while the other may be a suction type gripper or hand that is used to push, pull, or drag an object up or down the ramp. Or, a first gripper on a first arm may be used grasp an object and lift from above while a second gripper on a second arm is used to support the object from below. In some embodiments, two or more different robots each may have one or more arms, potentially with different end effectors mounted, and the robots may be operated to work in cooperation to perform a task, each using its associated arm(s) and the respectively mounted end effectors to perform the task.

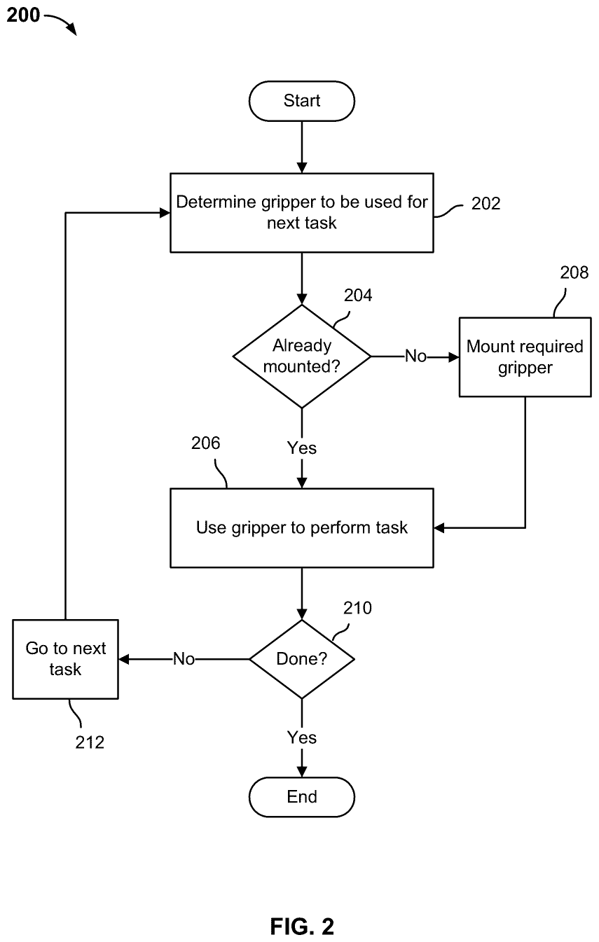

FIG. 2 is a flow diagram illustrating an embodiment of a process to perform a robotic task with autonomous gripper selection. In various embodiments, the process 200 of FIG. 2 may be performed by a robot, e.g., robot 102, 104 of FIG. 1 and/or a control computer, such as control computer 120 of FIG. 1. In the example shown, at 202, a gripper to be used to perform the next (or first) task is determined. If at 204 it is determined that that required gripper is already mounted, then at 206 the gripper is used to perform the task. If not already mounted (204), then at 208 the required gripper is mounted and used at 206 to perform the task. If more tasks remain to be performed (210), processing moves on to the next task (212) and steps 202, 204, 206, and/or 208 are performed, as applicable, until done (210).

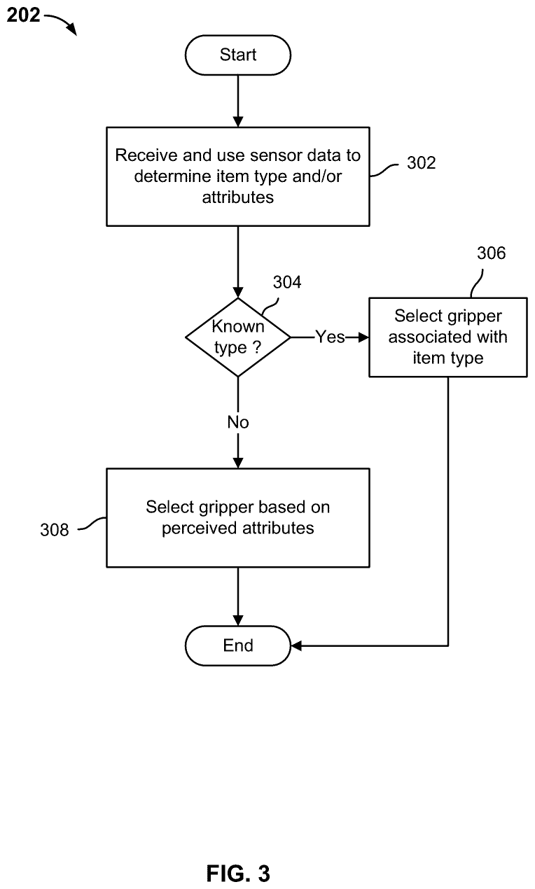

FIG. 3 is a flow diagram illustrating an embodiment of a process to select a gripper autonomously to perform a task. In various embodiments, the process of FIG. 3 may be used to implement step 202 of the process 200 of FIG. 2. In the example shown, at 302, sensor data is received and used to determine an item type and/or attributes of the item to be manipulated. If the item is determined at 304 to be of a known type, at 306 a gripper associated with the item type is selected. If the item type is not determined or known (304), then at 308 a gripper is selected based on one or more perceived and/or determined attributes of the item, e.g., item shape, size, weight, material, rigidity, fragility, etc.

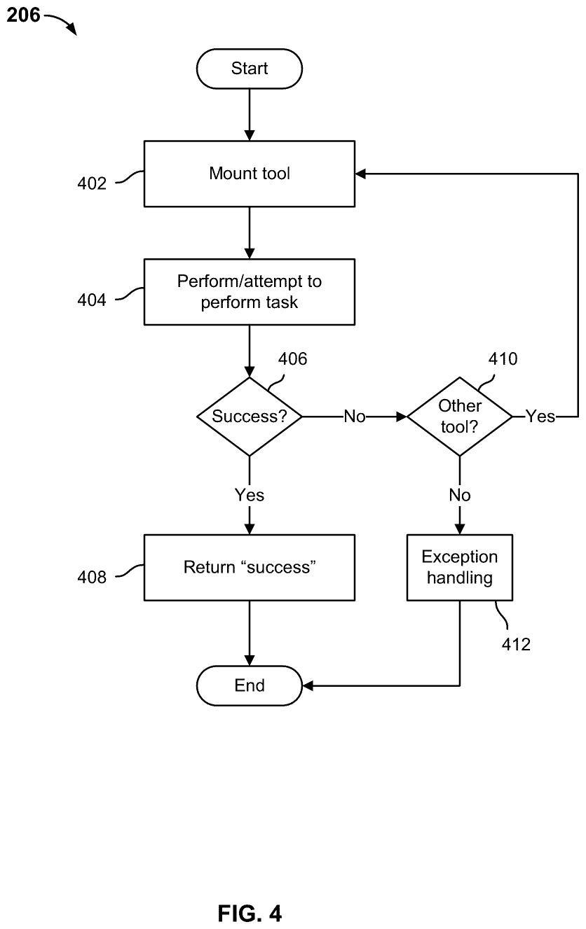

FIG. 4 is a flow diagram illustrating an embodiment of a process to perform a task using a selected gripper. In various embodiments, the process of FIG. 3 may be used to implement step 206 of the process 200 of FIG. 2. In the example shown, at 402 a required tool is mounted. At 404, the tool is used to perform or attempt to perform the task. If at 406 it is determined that the task has been performed successfully, then at 408 a result of “success” is returned, e.g., to a process or module requesting and/or managing performance of the task. If it is determined at 406 that the task has not been performed successfully, then it is determined at 410 whether another tool suitable to do the task is available. If so, the alternative tool is mounted at 402 and used at 404 to perform or attempt to perform the task. If at 410 it is determined that no other tool is available, exception handling is performed at 412. For example, a human worker may be called to assist, or failure to complete the task may be logged, or an alert sent, etc.

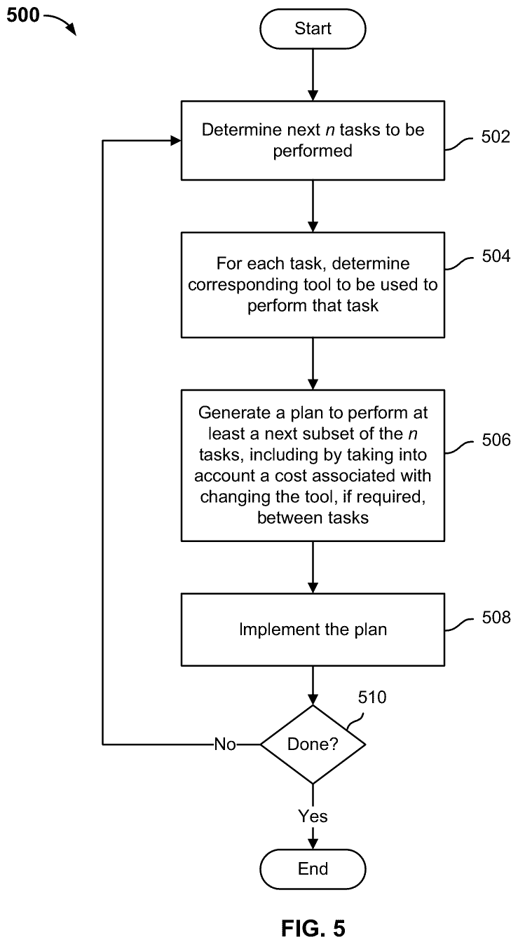

FIG. 5 is a flow diagram illustrating an embodiment of a process to perform a set of tasks potentially requiring use of two or more different grippers. In various embodiments, the process 500 of FIG. 5 may be performed by a control computer, such as control computer 120 of FIG. 1. In the example shown, at 502 the next n tasks to be performed are determined. For example, in the example shown in FIG. 1, the system may determine that items 108, 110, and 112 remain to be moved from pick area 114 to destination 116. Or, the next n items coming down a conveyor towards the robot may be perceived and characterized via computer vision.

At 504, for each task, the system determines a corresponding tool (or tools) usable to perform the task. At 506, a plan is generated to perform at least a next subset of the n tasks, including by taking into account a cost associated with changing the tool, if required, between tasks. For example, if the subset includes a first plurality of items for which a first gripper is to be used and a second plurality of items for which a second gripper is to be used, then the plan might include picking/placing the first plurality of items using the first gripper first, then picking/placing the second plurality of items using the second gripper, to minimize the number of times a gripper must be unmounted or mounted. Or, in another example, a gripper swap may be scheduled to occur at a time when the robot may be waiting for another reason, such as removal of a full pallet or other receptacle and placement of a new, empty onc. At 508, the plan is implemented.

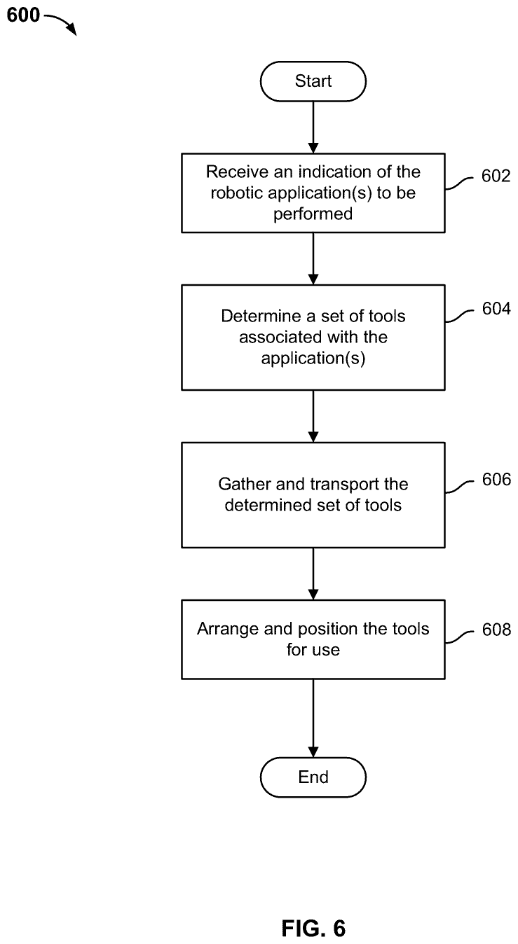

FIG. 6 is a flow diagram illustrating an embodiment of a process to determine and assemble a set of grippers to be used to perform tasks associated with a robotic application. In various embodiments, the process 500 of FIG. 5 may be performed by a control computer, such as control computer 120 of FIG. 1. In the example shown, at 602, an indication is received of one or more robotic applications (e.g., palletization, singulation, sortation, truck or container loading/unloading, baggage handling, etc.) to be performed. A robotic application may be associated with a defined set of tasks or types of task and/or an associated set of items and/or types of item to be handled. At 604, a set of tools (grippers, etc.) associated with the application(s) is determined, and at 606 the required tools are gathered and transported, or caused to be transported, to the applicable workspace. In some cases, the robot may carry the required tools to the workspace, e.g., by placing them on or in a rover comprising the robot and/or a table, container, rack, or other receptacle mounted thereon. A trailer or helper robot may also be used to transport tools to the workspace. At 608, upon the robot and the tools arriving at the workspace, the tolls are arranged and/or positioned for ready mounting, use, and unmounting. For example, the tools may be place on a gripper wall, such as gripper wall 132 of FIG. 1.

In various embodiments, a mounting/unmounting interface is disposed at the free moving end of the robotic arm or other robot. The interface may comprise a variety of structures and types of structure that enables a gripper to be mounted and unmounted without human intervention and which secures the gripper to the robotic arm or other robot securely when mounted, including when loaded up to a rated and/or design working load. In some embodiments, the interface facilitates providing to a mounted gripper one or more resources required by the gripper to be operated, such as vacuum, compressed air, electrical power, and network or other communications and/or control signal transmission facilities.

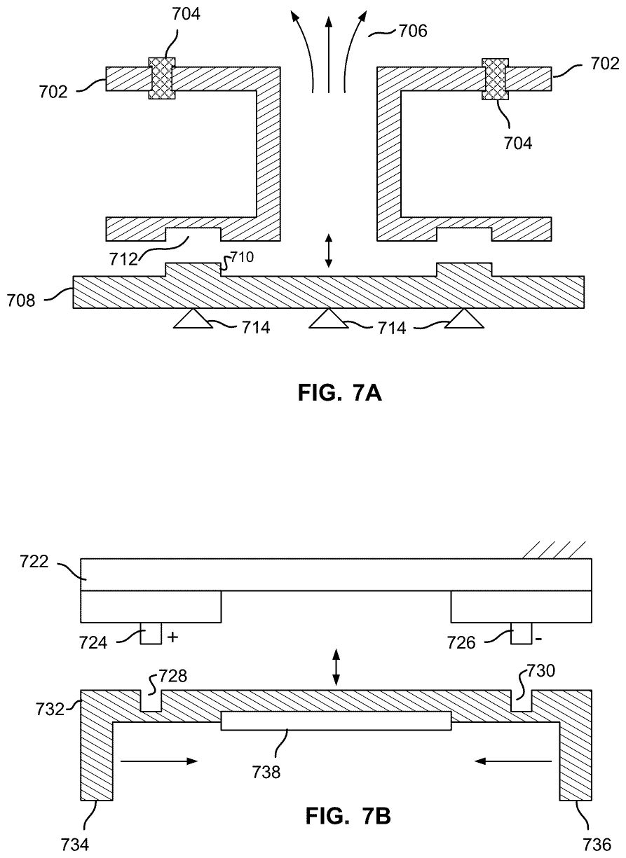

FIG. 7A is a diagram illustrating an example of a gripper mounting mechanism in an embodiment of a robotic system with autonomous gripper selection. In the example shown, a vacuum based gripper mount 702 secured to a robotic arm by bolts 704 applies a vacuum, represented by arrows 706, to mount a suction-type gripper 708. Tabs or extensions 710 on gripper 708 are aligned with recesses 712 on gripper mount 702 to ensure proper mounting and suction seal.

Locking structures not shown in FIG. 7A, such as a spring-loaded locking pin or other plunger, may retract (be depressed into an indent as the tabs 710 enter the recesses 712 and may slide into a position to lock the gripper 708 in place, e.g., once the tabs 710 have slid fully into the recesses 712. To unmount, the robot may press the gripper 708 in a certain manner or direction to release the locking pin/plunger, enable the gripper 708 to be unmounted.

Once gripper 708 is mounted, suction from the same vacuum source can be applied via suction cups 714 to engage an item to be picked/placed by the robot.

FIG. 7B is a diagram illustrating an example of a gripper mounting mechanism in an embodiment of a robotic system with autonomous gripper selection. In the example shown, gripper mount 722 fixed to the distal end of a robotic arm or other robot includes electrical terminals 724, 726, which are aligned with and inserted into receptacles 728, 730 to provide power to the gripper 732. In some embodiments, electrical power may be used to mount the gripper 732 to mounted 722, e.g., by activating an electro-magnet. In other embodiments, a mechanical or other interlock may be used to mount the gripper 732 to mount 722.

In the example shown, gripper 732 is configured to grasp or ungrasp items by moving grabbers 734, 736 in or out, e.g., by actuating an electrical linear drive mechanism 738.

FIG. 7C is a diagram illustrating an example of a gripper mounting mechanism in an embodiment of a robotic system with autonomous gripper selection. In the example shown, gripper mount 742 fixed to a robotic arm or other robot uses suction, magnetism, or another force to mount a gripper 744 that resembles a large fork or spatula, much like a forklift. The gripper 744 can be inserted beneath a pallet 746 or similar receptacle and then lifted and carried to a destination location, such as one in which the same robot and/or another robot can mount and use one or more different types of gripper to pick/place items onto the pallet 746.

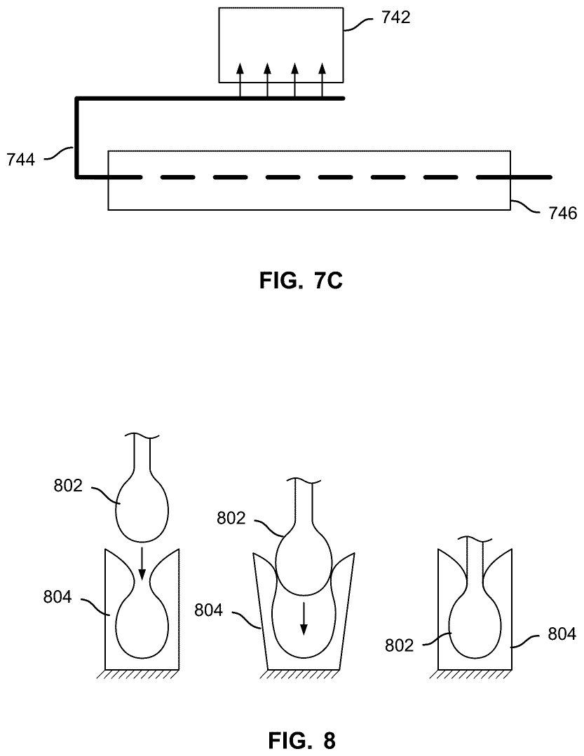

FIG. 8 is a diagram illustrating an example of a gripper mounting mechanism in an embodiment of a robotic system with autonomous gripper selection. In the example shown, gripper mount 802 comprises a durable and relatively rigid material in the shape of a bulb or other spheroid. To mount a gripper, the mount 802 is inserted into a receiver 804 having a recess having an interior space large enough to receive the mount 802 but an opening that is smaller in diameter than the widest part of the mount 802. The receiver 804 comprises material that is sufficiently pliable/deformable to admit the mount 802 if the robot applies sufficient force to insert the mount 802. After insertion, the receiver 804 regains its original shape and holds the gripper in place until the robotic arm pulls the mount 802 out of the receiver 804 while the receiver 804 and/or the gripper to which it is fixed/integrated is/are held in place, e.g., by a structure comprising or otherwise associated with a gripper wall to which the gripper is being returned.

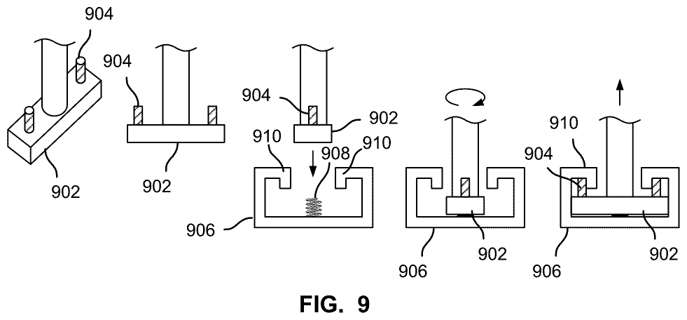

FIG. 9 is a diagram illustrating an example of a gripper mounting mechanism in an embodiment of a robotic system with autonomous gripper selection. In the example shown, mount 902 fixed to a robotic arm includes pins or other extensions 904. A gripper is mounted by inserting the mount 902 into a recess defined by a receiver 906 fixed to the gripper, at an orientation that allows the mount 902 to enter the recess and compress a spring 908. The mount 902 is then rotated, e.g., 90 degrees, and pulled up to cause the pins or other extensions 904 to enter and engage recesses defined by lips/overhangs 908 and 910 of the receiver 906, thereby locking the mount 902 inside the receiver 906 and securely mounting to the robot the gripper on/in which the receiver 906 is fixed and/or integrated.

While specific examples of mechanisms to mount a gripper are shown in FIGS. 7A, 7B, 7C, 8, and 9, in various embodiments a wide range of other mechanisms may be used. Design considerations include ensuring the robot side mount can be used to engage a gripper securely without human intervention by performing basic actions a robotic arm or other robot is capable to perform without human intervention, such as pushing in or pulling out with a prescribed force, rotating, etc.

In various embodiments, a gripper/tool mount/unmount mechanism is characterized by one or more of the following:
No actuators
Use robot motion to engage/disengage tools
For example:
   Bayonet hook with spring-loaded locking pin
      Robot pushes in to engage and pulls out to disengage
      Gripper wall holds tool in axis robot pushes and allows movement out in a different axis
      Clip force strong enough to hold heaviest EOAT+SKU at max speed
      Reverse action to disengage tool
   Spring-loaded collar
      Robot slides gripper into slot
      Robot pulls or pushes sides of locking collar against slot edges to release gripper
      Robot uses simple force to push through spring-loaded collar when picking up a gripper
   Key and lock design
      Gripper wall has simple “key” shaped protrusion
      Robot pushes gripper onto key, which depresses locking pin
      Robot rotates with locking pin depressed to release gripper
      reverse action to engage tool
      “Key” also operates as a hanger for wall storage

In various embodiments, techniques disclosed herein may be used to perform a wide variety of tasks, with respect to a variety of objects, in many different contexts and/or robotic applications, including without limitation for object “pick & place” for robotic applications such as Singulation, Palletization, Depalletization, Truck Loading/unloading and automated warehouse applications.

In various embodiments, techniques disclosed herein may include and/or be used in connection and/or combination with techniques described in U.S. patent application Ser. No. 16/034,544, filed Jul. 13, 2018, entitled Robotic Toolset and Gripper, now U.S. Pat. No. 10,500,735, the application contents of which are incorporated herein by reference for all purposes.

Although the foregoing embodiments have been described in some detail for purposes of clarity of understanding, the invention is not limited to the details provided. There are many alternative ways of implementing the invention. The disclosed embodiments are illustrative and not restrictive.

1. A robotic system, comprising:
communication interface configured to receive sensor data from a sensor in a workspace; and
a processor coupled to the communication interface and configured to:
use the sensor data to determine an end effector to be used to perform a task with respect to an object in the workspace;
autonomously mount the end effector on a free moving end of a robotic arm comprising the robotic system; and
use the robotic arm and end effector to perform the task with respect to the object.

2. The system of claim 1, wherein the sensor comprises a camera and the sensor data comprises image data.

3. The system of claim 2, wherein the processor is configured to use the image data to determine an attribute of the object and toe determine the end effector to be used to perform the task based at least in part on the attribute.

4. The system of claim 1, wherein determining the end effector includes selecting the end effector from among a plurality of end effectors available to be mounted on the free moving end of the robotic arm.

5. The system of claim 1, wherein the robotic arm is mounted on a robotically controlled rover and wherein autonomously mounting the end effector on the free moving end of the robotic arm includes operating the rover under robotic control to position the robotic arm in a location from which the end effector is within reach of the free moving end of the robotic arm.

6. The system of claim 1, wherein the sensor data comprises RF tag data associated with the end effector and the processor is configured to use the RF tag data to locate and mounted the end effector to be used to perform the task.

7. The system of claim 1, wherein autonomously mounting the end effector on the free moving end of the robotic arm includes using computer vision to move an end effector mount structure on the free moving end of the robotic arm to a position adjacent to a corresponding structure on the end effector and using force control to engage the end effector mount structure with the corresponding structure on the end effector.

8. The system of claim 7, wherein the end effector mount structure comprises a spheroid or similar protrusion fixed at the free moving end of the robotic arm; the corresponding structure comprises a receiver that defines an interior space of a same or similar size and shape as the spheroid or similar protrusion but having an opening that is smaller than a largest diameter of the spheroid or similar protrusion; at least the opening of the receiver comprises a material that is compressible or otherwise deformable to admit the spheroid or similar protrusion upon application of sufficient insertion force; and force control is used to insert the spheroid or similar protrusion into the receiver.

9. The system of claim 7, wherein the end effector mount structure comprises a cross member; the corresponding structure comprises a receiver that includes an interior void into which the cross member of the end effector mount structure is inserted through a slot and then rotated into a position such that the cross member is not aligned with the slot; and the end effector mount structure further includes one or more locking pins to secure the end effector mount structure in the corresponding structure.

10. The system of claim 1, wherein autonomously mounting the end effector on the free moving end of the robotic arm includes using suction to grasp and hold the end effector to the free moving end of the robotic arm.

11. The system of claim 10, wherein the end effector comprises a suction type end effector and wherein the suction used to grasp and hold the end effector to the free moving end of the robotic arm is further supplied to the end effector as a resource.

12. The system of claim 1, wherein the end effector comprises an electrically operated end effector and wherein the end effector is mounted to the free moving end of the robotic arm via an end effector mounting structure that supplies electrical power to the end effector when mounted.

13. The system of claim 1, wherein autonomously mounting the end effector includes recognizing that the end effector determined to be used to perform the task is already mounted.

14. The system of claim 1, wherein the end effector comprises a first end effector and wherein autonomously mounting the first end effector includes unmounting a second end effector mounted previously on the free moving end of the robotic arm.

15. The system of claim 1, wherein the task comprises one of a plurality of tasks, each associated with a respective object in the workspace, and wherein the processor is further configured to determine for each task a corresponding end effector to be used to perform that task and to generate a plan to perform at least a subset of the plurality of tasks, including by taking into account a cost associated with changing between two different corresponding end effectors between tasks.

16. The system of claim 1, wherein the task is associated with a first robotic application included in a plurality of robotic applications and wherein the processor is configured to determine a set of end effectors associated with the first robotic application and to select the end effector from among the set of end effectors associated with the first robotic application.

17. The system of claim 16, wherein the processor is further configured to use the robotic arm to select the set of end effectors associated with the first robotic application from a larger group of available end effectors, based at least in part on the robotic system being configured to perform tasks associated with the first robotic application.

18. The system of claim 1, wherein the end effector is included in a set of end effectors disposed on an end effector wall or other repository comprising structures to enable the end effectors comprising the set to be viewed, mounted, and unmounted.

19. A method, comprising:
receiving sensor data from a sensor in a workspace;
using the sensor data to determine an end effector to be used to perform a task with respect to an object in the workspace;
autonomously mounting the end effector on a free moving end of a robotic arm comprising the robotic system; and
using the robotic arm and end effector to perform the task with respect to the object.

20. A computer program product embodied in a non-transitory computer readable medium and comprising computer instructions for:
receiving sensor data from a sensor in a workspace;
using the sensor data to determine an end effector to be used to perform a task with respect to an object in the workspace;
autonomously mounting the end effector on a free moving end of a robotic arm comprising the robotic system; and
using the robotic arm and end effector to perform the task with respect to the object.
